(19) United States
(12) Patent Application Publication
(10) Pub. No.: US 2021/0011365 A1
(43) Pub. Date: Jan. 14, 2021

(54) LIGHT SOURCE DEVICE AND PROJECTION DISPLAY DEVICE

(71) Applicant: Panasonic Intellectual Property Management Co., Ltd., Osaka (JP)

(72) Inventor: Takaaki TANAKA, Osaka (JP)

(21) Appl. No.: 17/034,684

(22) Filed: Sep. 28, 2020

Related U.S. Application Data
(63) Continuation of application No. PCT/JP2019/016917, filed on Apr. 22, 2019.

(30) Foreign Application Priority Data
Jul. 11, 2018 (JP) 2018-131162

(51) Int. Cl. G03B 21/20; G02B 26/00; G02B 5/30; G03B 21/00; H04N 9/31; C09K 11/77

(52) U.S. Cl. CPC G03B 21/204; G03B 21/2066; G03B 21/208; G03B 21/2073; G02B 26/008; C09K 11/7721; G03B 21/006; G03B 21/008; H04N 9/3155; H04N 9/3197; H04N 9/3161; G02B 5/3083

(57) ABSTRACT

A light source device includes a solid-state light source, a dichroic mirror, a first condensing element, a fluorescent plate, a second condensing element, a retardation plate, and a reflection plate. The dichroic mirror separates light from the solid-state light source into first light and second light, and combines blue light and light containing green and red components, the blue light being obtained by converting polarization of the second light, the light containing green and red components being obtained by converting a wavelength of the first light. The first condensing element condenses the first light separated by the dichroic mirror. The fluorescent plate converts the wavelength of the first light condensed by the first condensing element. The second condensing element condenses the second light separated by the dichroic mirror. The retardation plate converts polarization of the second light condensed by the second condensing element.

### TECHNICAL FIELD

The present disclosure relates to a projection display device that illuminates an image formed on a small-sized light valve with illumination light, and enlarged and projects the image on a screen by a projection lens.

### BACKGROUND ART

As a light source of a projection display device using a mirror deflection type digital micromirror device (DMD) or a light valve of a liquid crystal panel, many light source devices each using a solid-state light source of a semiconductor laser or a light emitting diode, which has a long life, have been disclosed. Among them, PTL 1 discloses a compact light source device using a retardation plate by utilizing polarization characteristics of light emitted from a solid-state light source. In addition, PTL 2 discloses a compact, highly efficient light source device using a low-cost retardation plate having excellent durability.

### CITATION LIST

### Patent Literatures

PTL 1: Japanese Patent No. 5874058

PTL 2: Unexamined Japanese Patent Publication No. 2018-13764

### SUMMARY

The present disclosure provides a compact, highly efficient light source device, and a bright, compact projection display device having a long life.

A first light source device of the present disclosure includes a solid-state light source, a dichroic mirror, a first condensing element, a fluorescent plate, a second condensing element, a retardation plate, and a reflection plate. The dichroic mirror separates light from the solid-state light source into first light and second light, and combines blue light and light containing green and red components, the blue light being obtained by converting polarization of the second light, the light containing green and red components being obtained by converting a wavelength of the first light. The first condensing element condenses the first light separated by the dichroic mirror. The fluorescent plate converts the wavelength of the first light condensed by the first condensing element. The second condensing element condenses the second light separated by the dichroic mirror. The retardation plate converts polarization of the second light condensed by the second condensing element. The reflection plate reflects the second light with the polarization converted by the retardation plate. The second condensing element is configured of a lens array.

Moreover, a second light source device of the present disclosure includes a solid-state light source, a dichroic mirror, a first condensing element, a fluorescent plate, a second condensing element, a retardation plate, and a reflection plate. The dichroic mirror separates light from the solid-state light source into first light and second light, and combines blue light and light containing green and red components, the blue light being obtained by converting polarization of the second light, the light containing green and red components being obtained by converting a wavelength of the first light. The first condensing element condenses the first light separated by the dichroic mirror. The fluorescent plate converts the wavelength of the first light condensed by the first condensing element. The second condensing element condenses the second light separated by the dichroic mirror. The retardation plate converts polarization of the second light condensed by the second condensing element. The reflection plate reflects the second light with the polarization converted by the retardation plate. The first condensing element is configured of a lens array.

According to the present disclosure, a compact, highly efficient light source device can be configured by configuring, with a lens array, a light condensing element that condenses light from a solid-state light source on a reflection plate or a fluorescent plate. Therefore, it is possible to achieve a bright, compact projection display device having a long life.

### BRIEF DESCRIPTION OF DRAWINGS

FIG. 1 is a configuration diagram of a light source device according to a first exemplary embodiment of the present disclosure.

FIG. 2 is a configuration diagram of a light source device according to a second exemplary embodiment of the present disclosure.

FIG. 3A is a configuration diagram of a fluorescent plate according to the second exemplary embodiment of the present disclosure.

FIG. 3B is a configuration diagram of a fluorescent plate in a modification of the second exemplary embodiment of the present disclosure.

FIG. 4 is a configuration diagram of a light source device according to a third exemplary embodiment of the present disclosure.

FIG. 5 is a configuration diagram of a projection display device according to a fourth exemplary embodiment of the present disclosure.

FIG. 6 is a configuration diagram of a projection display device according to a fifth exemplary embodiment of the present disclosure.

### DESCRIPTION OF EMBODIMENTS

Hereinafter, exemplary embodiments for carrying out the present disclosure will be described with reference to the drawings.

### First Exemplary Embodiment

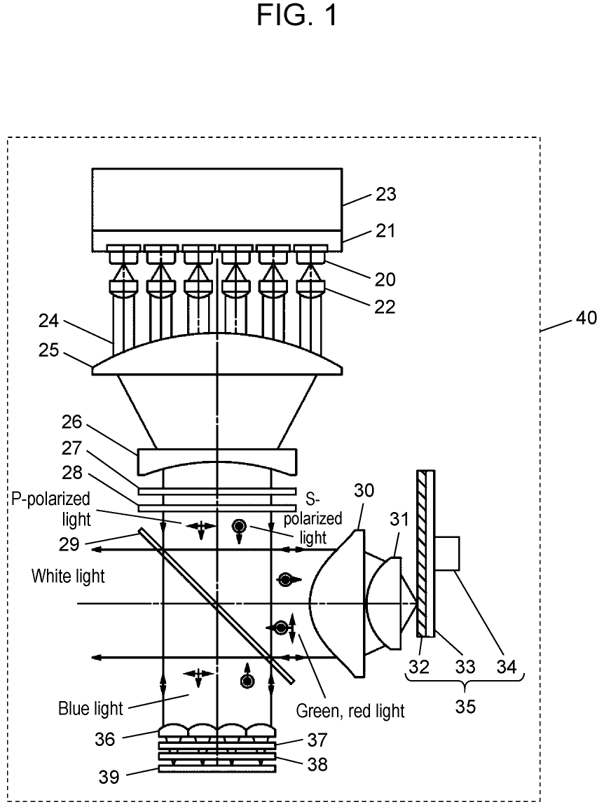

FIG. 1 is a configuration diagram of a light source device showing a first exemplary embodiment.

Light source device 40 includes semiconductor lasers 20 that are solid-state light sources, heat dissipation plate 21, condensing lenses 22, heat sink 23, lens 25, lens 26, first diffusion plate 27, first retardation plate 28, dichroic mirror 29, condenser lenses 30, 31 that configure a first condensing element, fluorescent plate 35, lens array 36 that is a second condensing element, second diffusion plate 37, and second retardation plate 38 that is a ¼ wavelength plate, and reflection plate 39. Fluorescent plate 35 is configured of aluminum substrate 33 on which a reflection film (not shown) and fluorescent material layer 32 are formed, and motor 34. FIG. 1 shows an appearance of each light flux 24 emitted from each of semiconductor lasers 20 that are solid-state light sources, and polarization directions of light entering dichroic mirror 29 and light emitted from dichroic mirror 29.

On heat dissipation plate 21, 24 (6×4) semiconductor lasers 20 and condensing lenses 22 quadratically arranged are disposed two-dimensionally at regular intervals. Heat sink 23 is for cooling semiconductor lasers 20. Each of semiconductor lasers 20 emits blue light with a wavelength width of 447 nm to 462 nm, and emits linearly polarized light. Each of semiconductor lasers 20 is disposed such that a polarization direction of the blue light emitted from semiconductor laser becomes S-polarized with respect to an incident surface of dichroic mirror 29. The light beams emitted from the plurality of semiconductor lasers 20 are respectively condensed by corresponding condensing lenses 22 and converted into parallel light fluxes 24. A group of light fluxes 24 is further reduced in diameter by convex lens 25 and concave lens 26, and enters first diffusion plate 27.

First diffusion plate 27 is made of glass and diffuses light in a shape of fine irregularities on a surface or in a shape of a microlens. A diffusion angle, which is a half-value angle width that is 50% of maximum intensity of diffused light, is as small as about 3 degrees, and maintains polarization characteristics. The light emitted from first diffusion plate 27 enters first retardation plate 28. First retardation plate 28 is a ¼ wavelength plate having a phase difference of ¼ wavelength near an emission center wavelength of semiconductor laser 20. When a P polarization direction in FIG. 1 is 0 degree, an optical axis of first retardation plate 28 is disposed at 71.5 degrees. First retardation plate 28 converts incident S-polarized light into light having a ratio of an S-polarized component of about 82% and a P-polarized component of about 18%, depending on a disposition angle of the optical axis. First retardation plate 28 can be rotationally adjusted, and rotating first retardation plate 28 allows the ratio of the S-polarized component and the P-polarized component to be adjusted. First retardation plate 28 is a fine-structured retardation plate that utilizes birefringence generated in a fine periodic structure smaller than a wavelength of light (see International Publication WO 2017/061170). The fine periodic-structured retardation plate is made of an inorganic material, and has excellent durability and reliability like an inorganic optical crystal such as quartz.

The light from first retardation plate 28, which is a ¼ wavelength plate, enters dichroic mirror 29. Dichroic mirror 29 has a characteristic of transmitting P-polarized light of semiconductor laser light having a wavelength of 447 nm to 462 nm with a high transmittance, and reflecting S-polarized light with a high reflectance of 96% or more, and a characteristic of transmitting P-polarized light and S-polarized light of green light and red light with a high transmittance of 96% or more.

Blue light of the S-polarized light reflected by dichroic mirror 29 is condensed by condenser lenses 30, 31, and when a diameter at which light intensity becomes 13.5% of peak intensity is defined as a spot diameter, the spot diameter is superimposed on spot light having a spot diameter of 1.5 mm to 2.5 mm, and enters fluorescent plate 35. First diffusion plate 27 diffuses the light such that the spot light has the desired diameter. Fluorescent plate 35 is a rotation-controllable circular substrate including aluminum substrate 33 on which the reflection film and fluorescent material layer 32 are formed, and motor 34 in a central portion. The reflection film of fluorescent plate 35 is a metal film or a dielectric film that reflects visible light and is formed on the aluminum substrate. Further, fluorescent material layer 32 is formed on the reflection film. In fluorescent material layer 32, a Ce-activated YAG yellow fluorescent material that is excited by blue light and emits yellow light containing green and red components is formed. A typical chemical composition of a crystal matrix of this fluorescent material is Y₃Al₅O₁₂. Fluorescent material layer 32 is formed in an annular shape. Fluorescent material layer 32 excited by the spot light emits the yellow light containing the green and red components. Aluminum substrate 33 of fluorescent plate 35 is made of aluminum, and can be rotated to suppress temperature rise of fluorescent material layer 32 due to the excitation light and stably maintain a fluorescence conversion efficiency. The light that has entered fluorescent material layer 32 has a wavelength thereof converted and becomes fluorescence of the yellow light containing the green and red components, and is emitted from fluorescent plate 35. Further, the light emitted to a reflection film side is reflected by the reflection film and emitted from fluorescent plate 35. The yellow light including the green and red components emitted from fluorescent plate 35 becomes natural light, is condensed again by condenser lenses 30, 31, is converted into substantially parallel light, and is then transmitted through dichroic mirror 29.

On the other hand, the P-polarized blue light that is transmitted through dichroic mirror 29 enters lens array 36, which is the second condensing element, and is condensed. Lens array 36 is configured of 16 lens cells arranged in 4×4. A focal distance of each of the lens cells configuring lens array 36 is set such that a condensing angle is less than or equal to 40 degrees, and condensed spots are formed near reflection plate 39. By using the lens array as the second condensing element, the focal distance of the lens can be shortened in accordance with a number of arrays in the lens array as compared with a conventional condenser lens, and an optical path length can be shortened, so that the compact optical system can be configured. While as lens array 36, one lens array is used, a plurality of lens arrays may be used. By configuring lens array 36 using the plurality of lens arrays, a spherical aberration of each of the lens cells is corrected, and the light can be condensed with higher efficiency. Lens array 36 can be manufactured at low cost by a molding method.

The light condensed by lens array 36 enters second diffusion plate 37. Second diffusion plate 37 diffuses the incident light to make light intensity distribution uniform and eliminate speckle of the laser light. Second diffusion plate 37 results from forming a diffusion surface into a fine irregular shape or into a microlens shape on a glass surface of a thin plate. Second diffusion plate 37 has a diffusion angle of about 4 degrees with respect to light transmitted once through the diffusion surface, and maintains the polarization characteristics. The light transmitted through second diffusion plate 37 enters second retardation plate 38, which is a ¼ wavelength plate. Second retardation plate 38 is a retardation plate having a phase difference of ¼ wavelength near the emission center wavelength of semiconductor laser 20. Second retardation plate 38 has an optical axis thereof arranged at 45 degrees when the P polarization direction in FIG. 1 is set at 0 degrees. Second retardation plate 38 converts the incident linearly polarized light into circularly polarized light. Second retardation plate 38 is a fine-structured retardation plate made of an inorganic material, and change in phase difference with respect to an incident angle is much smaller than that of a retardation plate of an inorganic optical crystal such as quartz. The light transmitted through second retardation plate 38 and converted into the circularly polarized light has a phase thereof inverted by reflection plate 39 on which a reflection film such as aluminum or a dielectric multilayer film is formed, becomes divergent light as reverse circularly polarized light, and is then transmitted through second retardation plate 38 to be converted into S-polarized light. Further, since a member that disturbs the polarized light is not disposed between second retardation plate 38 and reflection plate 39, it is possible to convert the P-polarized light into the S-polarized light with high efficiency.

The S-polarized light converted by second retardation plate 38 is again diffused by second diffusion plate 37, is then converted into parallel light by lens array 36, and is reflected by dichroic mirror 29.

In this way, the fluorescent light (the yellow light containing the green and red components) from fluorescent plate 35, and the blue light that is efficiently converted polarized light are combined by dichroic mirror 29, and white light is emitted. The yellow light containing the green and red components of the fluorescence emission, and the blue light of semiconductor laser 20 can bring about a light emission characteristic with good white balance. With this light emission spectrum characteristic, monochromatic light having a desired chromaticity coordinate can be obtained even if it is separated into blue light, green light, and red light, which are three primary colors, by an optical system of the projection display device.

Although each of the ¼ wavelength plates as the first and second retardation plates has been described using the fine-structured retardation plate, a thin film retardation plate utilizing birefringence due to oblique deposition of a dielectric material (see Unexamined Japanese Patent Publication No. 2012-242449) may be used. The thin film retardation plate is made of an inorganic material, and has excellent durability and reliability like an inorganic optical crystal such as quartz. Further, since a thin film wavelength plate is laminated and formed so as to have a film thickness sufficiently smaller than the wavelength of light, an entire oblique deposition layer serves as a retardation plate having one optical axis. Therefore, change in phase difference with respect to the incident angle is much smaller than that of the retardation plate of an inorganic optical crystal such as quartz.

As described above, the light source device of the first exemplary embodiment separates the blue light from the plurality of semiconductor lasers into two by the dichroic mirror, and efficiently combines the yellow light containing the green and red components, and the other separated blue light (second light), the yellow light being excited and emitting the light by one separated blue light (first light), by which the white light can be obtained. Since the other blue light is condensed using the lens array, a compact, highly efficient light source device can be configured.

### Second Exemplary Embodiment

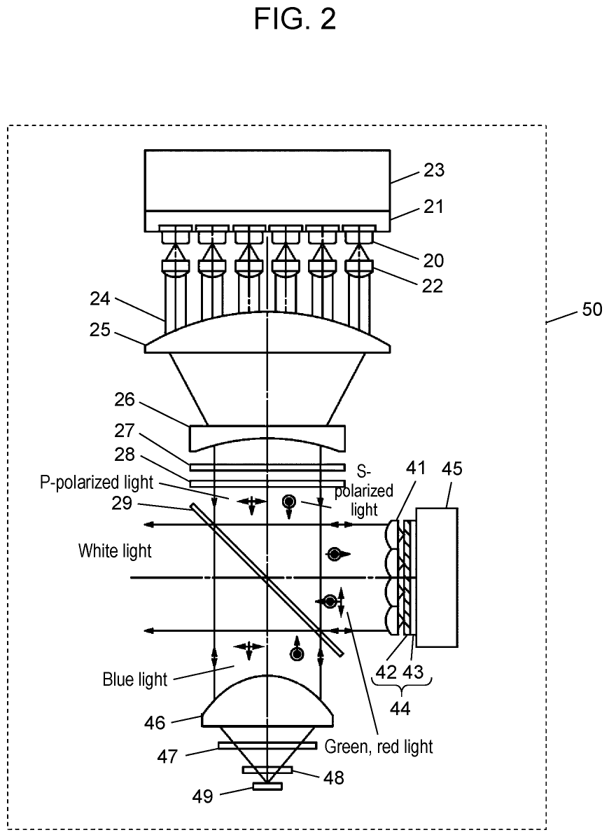

FIG. 2 is a configuration diagram of a light source device showing a second exemplary embodiment.

In light source device 50 of the second exemplary embodiment, semiconductor lasers 20, heat dissipation plate 21, condensing lenses 22, heat sink 23, lenses 25, 26, first diffusion plate 27, first retardation plate 28, dichroic mirror 29 are similar to those of light source device 40 of the first exemplary embodiment, and thus are denoted by the same reference marks. Light source device 50 of the present second exemplary embodiment includes lens array 41 that is a first condensing element, fluorescent plate 44 configured of aluminum substrate 43 on which fluorescent material layer 42 and a reflection film (not shown) are formed, heat sink 45, condenser lens 46, which is a second condensing element, second diffusion plate 47, second retardation plate 48, and reflection plate 49. FIG. 2 shows an appearance of each light flux 24 emitted from each of semiconductor lasers 20 that are solid-state light sources, and polarization directions of light entering dichroic mirror 29 and light emitted from dichroic mirror 29.

The light beams emitted from the plurality of semiconductor lasers 20 are condensed by corresponding condensing lenses 22 respectively, and converted into parallel light fluxes 24. A group of light fluxes 24 is further reduced in diameter by convex lens 25 and concave lens 26, and enters first diffusion plate 27. First diffusion plate 27 diffuses light entering with a diffusion angle of about 3 degrees. The light emitted from first diffusion plate 27 enters first retardation plate 28. First retardation plate 28 is a ¼ wavelength plate having a phase difference of ¼ wavelength near an emission center wavelength of semiconductor laser 20, and S-polarized light entering first retardation plate 28 is converted into light at a ratio of an S-polarized component of about 82% and a P-polarized component of about 18%. First retardation plate 28 is a fine-structured retardation plate. The light from first retardation plate 28, which is a ¼ wavelength plate, enters dichroic mirror 29. Dichroic mirror 29 has a characteristic of transmitting P-polarized light of semiconductor laser light having a wavelength of 447 nm to 462 nm with a high transmittance, and reflecting S-polarized light with a high reflectance of 96% or more, and a characteristic of transmitting P-polarized light and S-polarized light of green light and red light with a high transmittance of 96% or more.

The S-polarized blue light of about 82%, which is reflected by dichroic mirror 29, is condensed by lens array 41 and enters fluorescent plate 44. Lens array 36 is configured of 16 lens cells arranged in 4×4. A focal distance of each of the lens cells configuring lens array 41 is set such that a condensing angle is more than or equal to 50 degrees, and a large number of minute condensed spots are formed on fluorescent material layer 42. By using the lens array as the first condensing element, the focal distance of the lens can be shortened in accordance with a number of lens arrays, as compared with the plurality of condenser lenses 30, 31 shown in FIG. 1, and an optical path length is shortened, so that a compact optical system can be configured. While as lens array 41, one lens array is used, a plurality of lens arrays may be used. By configuring lens array 41, using a plurality of lens arrays, a spherical aberration of each of the lens cell is corrected, and the light can be condensed with higher efficiency.

Fluorescent plate 44 is a non-rotating fixed substrate including aluminum substrate 43 on which a reflection film and fluorescent material layer 42 are formed. The reflection film of fluorescent plate 44 is a metal film or a dielectric film that reflects visible light, and is formed on the aluminum substrate. Further, fluorescent material layer 42 is formed on the reflection film. In fluorescent material layer 42, a Ce-activated YAG yellow fluorescent material that is excited by blue light and emits yellow light containing green and red components is formed. A typical chemical composition of a crystal matrix of this fluorescent material is Y₃Al₅O₁₂. Fluorescent material layer 42 is formed on an entire area of aluminum substrate 43. Fluorescent material layer 42 excited by the minute spot light emits the yellow light containing the green and red components. Since the spot light discretely enters fluorescent plate 44, a light density of the incident light can be reduced. Since a configuration is employed in which aluminum substrate 43 is made of aluminum and heat sink 45 is joined to aluminum substrate 43, temperature rise of fluorescent material layer 42 due to the excitation light can be suppressed, and fluorescence conversion efficiency can be stably maintained. Since the fluorescent plate is non-rotating, it is possible to configure a light source device with lower noise than the light source device using the rotation-controllable fluorescent plate.

The light that has entered fluorescent material layer 42 has a wavelength thereof converted and becomes yellow light fluorescence containing the green and red component components, and is emitted from fluorescence plate 44. Further, the light emitted to a reflection film side is reflected by the reflection film and emitted from fluorescent plate 44. The yellow light including the green and red components emitted from fluorescent plate 44 becomes natural light, is condensed again by lens array 41, is converted into substantially parallel light, and is then transmitted through dichroic mirror 29.

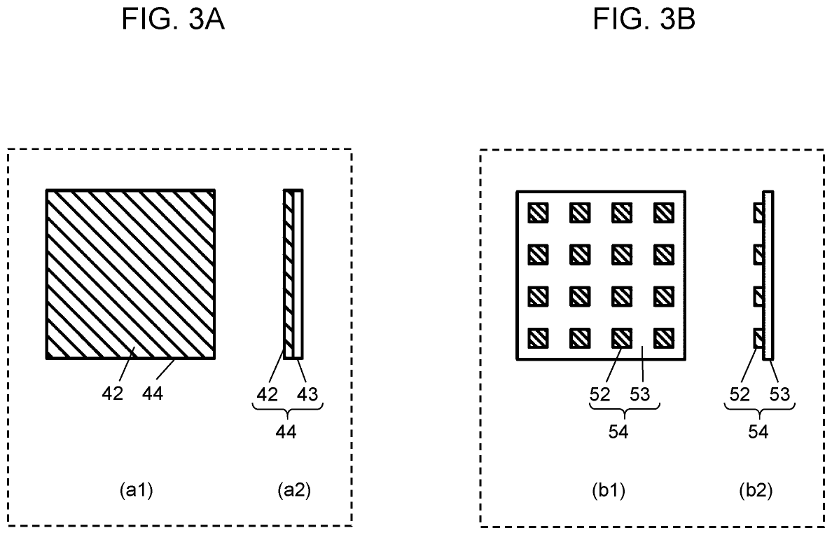

FIG. 3A shows a configuration of the fluorescent plate according to the second exemplary embodiment. FIG. 3A shows the configuration of fluorescent plate 44 in which fluorescent material layer 42 is formed in the entire area of aluminum substrate 43. Part (a1) of 3A is a plan view, and part (a2) of FIG. 3A is a side view.

Further, FIG. 3B shows a configuration of a fluorescent plate according to a modification of the second exemplary embodiment. FIG. 3B shows a configuration of fluorescent plate 54 in which fluorescent material layer 52 is formed on aluminum substrate 53 in discrete regions that the excitation light enters. Part (b1) of FIG. 3B is a plan view, and part (b2) of FIG. 3B is a side view. As compared with fluorescent plate 44, fluorescent plate 54 has a narrower fluorescent material layer region, and thus, can be configured at a lower cost. Therefore, fluorescent plate 54 may be used as the fluorescent plate.

On the other hand, the P-polarized blue light of about 18%, which is transmitted through dichroic mirror 29, enters condenser lens 46, which is the second condensing element, and is condensed. A focal distance of condenser lens 46 is set such that a condensing angle is less than or equal to 40 degrees, and a condensed spot is formed near reflection plate 49. The light condensed by condenser lens 46 enters second diffusion plate 47. Second diffusion plate 47 diffuses the incident light to make a light intensity distribution uniform and eliminates speckle of the laser light. Second diffusion plate 47 results from forming a diffusion surface into a fine irregular shape or into a microlens shape on a glass surface of a thin plate. In second diffusion plate 47, light transmitted once through the diffusion surface has a diffusion angle of about 4 degrees, and the polarization characteristics are maintained.

The light transmitted through second diffusion plate 47 enters second retardation plate 48, which is a ¼ wavelength plate. Second retardation plate 48 is a retardation plate having a phase difference of ¼ wavelength near the emission center wavelength of semiconductor laser 20. Second retardation plate 48 has an optical axis thereof arranged at 45 degrees when the P polarization direction in FIG. 2 is set to 0 degrees. Second retardation plate 48 converts the incident linearly polarized light into circularly polarized light. Second retardation plate 48 is a fine-structured retardation plate made of an inorganic material, and change in phase difference with respect to an incident angle is much smaller than that of a retardation plate of an inorganic optical crystal such as quartz.

The light transmitted through second retardation plate 48 and converted into circularly polarized light has a phase thereof inverted by reflection plate 49 formed with a reflection film such as aluminum or a dielectric multilayer film, and becomes divergent light as the reverse circularly polarized light, and is then transmitted through second retardation plate 48 to be converted into S-polarized light. The S-polarized light converted by second retardation plate 48 is again diffused by second diffusion plate 47, is then converted into parallel light by the condenser lens 46, and is reflected by dichroic mirror 29.

In this way, the fluorescent light (yellow light containing the green and red components) from fluorescent plate 44 and the blue light that has been efficiently polarized and converted are combined by dichroic mirror 29, and white light is emitted. The yellow light containing the green and red components of the fluorescence emission and the blue light of semiconductor laser 20 can bring about a light emission characteristic with good white balance. With this light emission spectrum characteristic, monochromatic light having a desired chromaticity coordinate can be obtained even if it is separated into blue light, green light, and red light, which are three primary colors, by an optical system of the projection display device.

As described above, the light source device of the second exemplary embodiment separates the blue light from the plurality of semiconductor lasers into two by the dichroic mirror, and efficiently combines the yellow light containing the green and red components, and the other separated blue light (second light), the yellow light being excited and emitting the light by one separated blue light (first light), by which the white light can be obtained. Since the one separated blue light is condensed by using the lens array, a compact, highly efficient light source device can be configured.

### Third Exemplary Embodiment

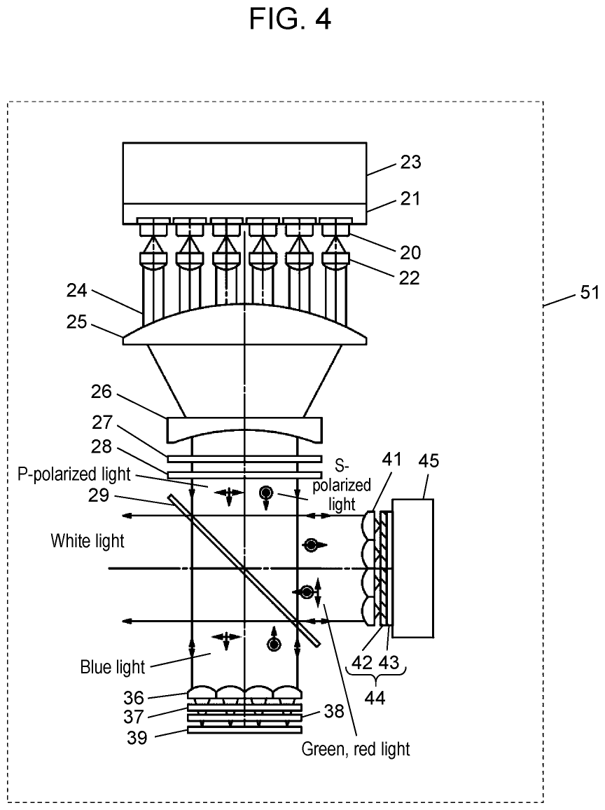

FIG. 4 is a configuration diagram of a light source device showing a third exemplary embodiment.

In light source device 51 of the third exemplary embodiment, semiconductor lasers 20, heat dissipation plate 21, condensing lenses 22, heat sink 23, lenses 25, 26, first diffusion plate 27, first retardation plate 28, dichroic mirror 29, lens array 36, second diffusion plate 37, second retardation plate 38 that is a ¼ wavelength plate, reflection plate 39 are similar to those of light source device 40 of the first exemplary embodiment, and thus, are denoted by the same reference marks. Further, in light source device 51 of the third exemplary embodiment, lens array 41, fluorescent plate 44 including aluminum substrate 43 on which fluorescent material layer 42 and a reflection layer are formed, and heat sink 45 are the same as those of light source device 50 of the second exemplary embodiment. That is, light source device 51 according to the third exemplary embodiment employs lens array 41 as the first condensing element, and lens array 36 as the second condensing element, so that the lens arrays are used for both the first condensing element and the second condensing element. FIG. 4 shows the appearance of each light flux 24 emitted from each of semiconductor lasers 20 that are solid-state light sources, and polarization directions of light entering dichroic mirror 29 and light emitted from dichroic mirror 29.

The light beams emitted from the plurality of semiconductor lasers 20 are condensed by corresponding condensing lenses 22 respectively, and converted into parallel light fluxes 24. A group of light fluxes 24 is further reduced in diameter by convex lens 25 and concave lens 26, and enters first diffusion plate 27. First diffusion plate 27 diffuses light entering with a diffusion angle of about 3 degrees. The light emitted from first diffusion plate 27 enters first retardation plate 28. First retardation plate 28 is a ¼ wavelength plate having a phase difference of ¼ wavelength near an emission center wavelength of semiconductor laser 20, and S-polarized light entering first retardation plate 28 is converted into light at a ratio of an S-polarized component of about 82% and a P-polarized component of about 18%. First retardation plate 28 is a fine-structured retardation plate. The light from first retardation plate 28, which is a ¼ wavelength plate, enters dichroic mirror 29. Dichroic mirror 29 has a characteristic of transmitting P-polarized light of semiconductor laser light having a wavelength of 447 nm to 462 nm with a high transmittance, and reflecting S-polarized light with a high reflectance of 96% or more, and a characteristic of transmitting P-polarized light and S-polarized light of green light and red light with a high transmittance of 96% or more.

The S-polarized blue light of about 82%, which is reflected by dichroic mirror 29, is condensed by lens array 41 and enters fluorescent plate 44. Lens array 36 is configured of 16 lens cells arranged in 4×4. A focal distance of each of the lens cells configuring lens array 41 is set such that a condensing angle is more than or equal to 50 degrees, and a large number of minute condensed spots are formed on fluorescent material layer 42. By using the lens array as the first condensing element, the focal distance of the lens can be shortened in accordance with a number of arrays of the lens array as compared with the plurality of condenser lenses 30, 31 shown in FIG. 1, so that a compact optical system can be configured. Further, in light source device 51, similarly to light source device 50 of the second exemplary embodiment, fluorescent plate 54 can also be used instead of fluorescent plate 44.

On the other hand, the P-polarized blue light that is transmitted through dichroic mirror 29 enters lens array 36, which is the second condensing element, and is condensed. Lens array 36 is configured of 4×4 arranged lens cells. A focal distance of each of the lens cells configuring lens array 36 is set such that a condensing angle is less than or equal to 40 degrees, and a condensed spot is formed near reflection plate 39. By using the lens array as the second condensing element, the focal distance of the lens can be shortened in accordance with a number of arrays in the lens array as compared with a conventional condenser lens, and an optical path length can be shortened, so that a compact optical system can be configured. While as lens array 36, one lens array is used, a plurality of lens arrays may be used. A spherical aberration of each of the lens cells is corrected by the plurality of lens arrays, and the light can be condensed with higher efficiency. The light condensed by lens array 36 enters second diffusion plate 37.

Second diffusion plate 37 diffuses the incident light to make light intensity distribution uniform and eliminate speckle of the laser light. The second diffusion plate results from forming a diffusion surface into a fine irregular shape or into a microlens shape on a glass surface of a thin plate. In second diffusion plate 37, light transmitted once through the diffusion surface has a diffusion angle of about 4 degrees, and the polarization characteristics are maintained. The light transmitted through second diffusion plate 37 enters second retardation plate 38, which is a ¼ wavelength plate. Second retardation plate 38 is a retardation plate having a phase difference of ¼ wavelength near an emission center wavelength of semiconductor laser 20. Second retardation plate 38 has an optical axis arranged at 45 degrees when the P polarization direction in the diagram is set to 0 degrees. Second retardation plate 38 converts the incident linearly polarized light into circularly polarized light. Second retardation plate 38 is a fine-structured retardation plate made of an inorganic material.

The light transmitted through second retardation plate 38 and converted into the circularly polarized light has a phase thereof inverted by reflection plate 39 on which a reflection film such as aluminum or a dielectric multilayer film is formed, becomes divergent light as reverse circularly polarized light, and is then transmitted through second retardation plate 38 to be converted into S-polarized light. The S-polarized light converted by second retardation plate 38 is again diffused by second diffusion plate 37, is converted into parallel light by lens array 36, and is reflected by dichroic mirror 29.

As described above, the light source device of the third exemplary embodiment separates the blue light from the plurality of semiconductor lasers into two by the dichroic mirror, and efficiently combines the yellow light containing the green and red components, and the other separated blue light (second light), the yellow light being excited and emitting the light by one separated blue light (first light), by which the white light can be obtained. The one separated blue lights and the other separated blue light are condensed by using a lens array, so that a compact, highly efficient light source device can be configured.

### Fourth Exemplary Embodiment

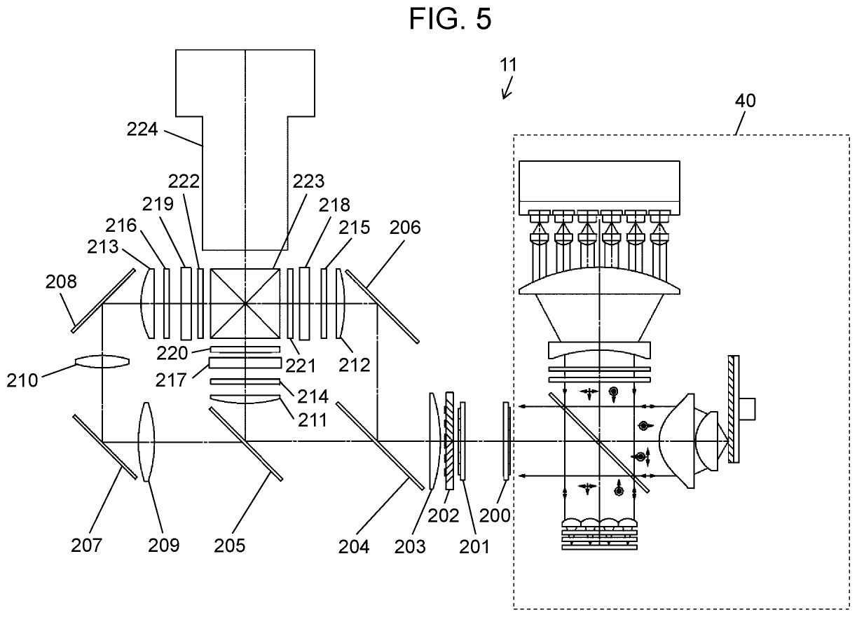

FIG. 5 shows projection display device 11 as a first projection display device showing a fourth exemplary embodiment. Projection display device 11 uses, as an image forming element, an active matrix transmissive liquid crystal panel in a TN (Twisted Nematic) mode or a VA (Vertical Alignment) mode, in which a thin film transistor is formed in a pixel region.

Light source device 40 of projection display device 11 is the light source device of the first exemplary embodiment.

Projection display device 11 includes light source device 40, first lens array plate 200, second lens array plate 201, polarization conversion element 202, superimposing lens 203, blue-reflecting dichroic mirror 204, green-reflecting dichroic mirror 205, reflection mirrors 206, 207, 208, relay lenses 209, 210, field lenses 211, 212, 213, incident-side polarization plates 214, 215, 216, liquid crystal panels 217, 218, 219, emission-side polarization plates 220, 221, 222, color combining prism 223 configured of a red-reflecting dichroic mirror and a blue-reflecting dichroic mirror, and projection lens 224.

White light from light source device 40 enters first lens array plate 200 configured of a plurality of lens elements. A light flux entering first lens array plate 200 is divided into a large number of light fluxes. The large number of divided light fluxes are converged on second lens array plate 201 configured of a plurality of lenses. Lens elements of first lens array plate 200 each have an aperture shape similar to that of liquid crystal panels 217, 218, 219. Lens elements of second lens array plate 201 each have a focal distance determined such that first lens array plate 200 and liquid crystal panels 217, 218, 219 have a substantially conjugate relationship. Light emitted from second lens array plate 201 enters polarization conversion element 202. Polarization conversion element 202 is configured of a polarized light separation prism and a ½ wavelength plate, and converts natural light from a light source into light in one polarization direction. Since fluorescent light is natural light, the natural light is polarized and converted in one polarization direction, but blue light enters as P-polarized light and is thus converted into S-polarized light. The light from polarization conversion element 202 enters superimposing lens 203. Superimposing lens 203 is a lens for superimposing and illuminating the light emitted from each of the lens elements of second lens array plate 201 on liquid crystal panels 217, 218, 219. In this way, first lens array plate 200, second lens array plate 201, polarization conversion element 202, and superimposing lens 203 configure an illumination optical system, and illuminate an illuminated region in a subsequent stage.

Light from superimposing lens 203 is separated into blue colored light, green colored light, and red colored light by blue-reflecting dichroic mirror 204 and green-reflecting dichroic mirror 205, which are color separation means. The green colored light is transmitted through field lens 211 and incident-side polarization plate 214, and enters liquid crystal panel 217. The blue colored light is reflected by reflection mirror 206, is then transmitted through field lens 212 and incident-side polarization plate 215, and enters liquid crystal panel 218. The red colored light is transmitted and refracted, and reflected by relay lenses 209, 210 and reflection mirrors 207, 208, is transmitted through field lens 213 and incident-side polarization plate 216, and enters liquid crystal panel 219. Three liquid crystal panels 217, 218, 219 change a polarization state of the incident light by controlling a voltage applied to each pixel according to a video signal, and form green, blue, and red images by combining incident-side polarization plates 214, 215, 216 and emission-side polarization plates 220, 221, 222 that are disposed orthogonally to respective transmission axes on both sides of respective liquid crystal panels 217, 218, 219, and modulating the light. The respective color light beams transmitted through emission-side polarization plates 220, 221, 222 are combined by color combining prism 223 in which the red and blue color light beams are reflected by the red-reflecting dichroic mirror and the blue-reflecting dichroic mirror, respectively, and are combined with the green color light beam, and then enter projection lens 224.

The light entering projection lens 224 is enlarged and projected on a screen (not shown). Since the light source device is compactly configured of the solid-state light sources, and emits the white light with high efficiency and good white balance, a projection display device having a long life and high brightness can be achieved. In addition, since three liquid crystal panels each of which utilizes the polarized light are used as the image forming elements instead of a time division method, it is possible to obtain a bright, high-definition projected image with good color reproduction without color breaking. In addition, as compared with the case of using three DMD (Digital Micromirror Device) elements, a total reflection prism is not required, and the prism for color combination is a small prism at an incidence of 45 degrees, so that the projection display device can be compactly configured.

As described above, light source device 40 used for the first projection display device of the fourth exemplary embodiment separates the blue light from the plurality of semiconductor lasers into two by the dichroic mirror, and efficiently combines the yellow light containing the green and red components, and the other separated blue light (second light), the yellow light being excited and emitting the light by one separated blue light (first light), by which the white light can be obtained, and further, the other separated blue light is condensed, using the lens array, so that light source device 40 is compact and highly efficient. Therefore, a compact, highly efficient projection display device can be configured. While light source device 40 shown in FIG. 1 is used as the light source device, light source devices 50, 51 shown in FIGS. 2, 4 may be used. In this case, a more compact light source device and projection display device can be configured.

While a transmissive liquid crystal panel is used as the image forming element, a reflective liquid crystal panel may be used. Using the reflective liquid crystal panel allows a more compact, higher definition projection display device to be configured.

### Fifth Exemplary Embodiment

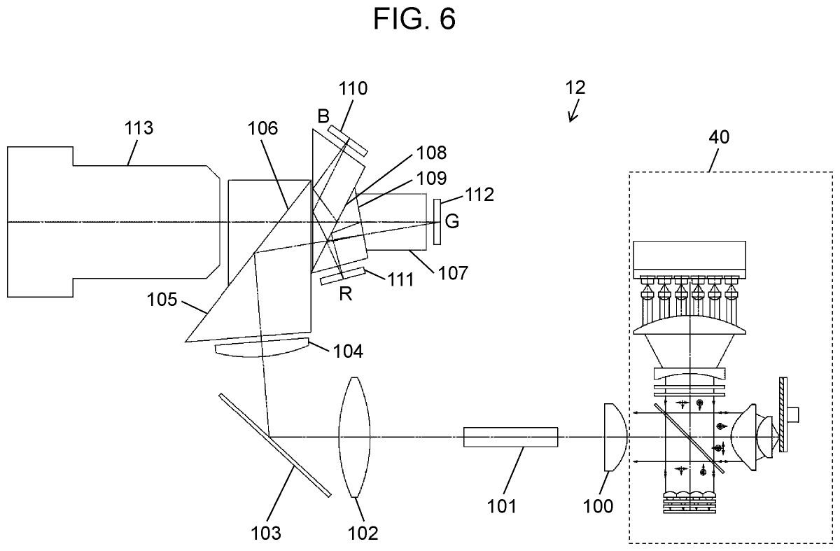

FIG. 6 shows projection display device 12 as a second projection display device showing a fifth exemplary embodiment. Projection display device 12 uses three DMDs as image forming elements. Light source device 40 of projection display device 12 is the light source device of the first exemplary embodiment.

The white light emitted from light source device 40 enters condensing lens 100 and is condensed on rod 101. Light entering rod 101 is reflected a plurality of times inside the rod, and is emitted with a light intensity distribution uniformalized. Light emitted from rod 101 is condensed by relay lens 102, is reflected by reflection mirror 103, is then transmitted through field lens 104, and enters total reflection prism 105. In this way, condensing lens 100, rod 101, relay lens 102, and reflection mirror 103 configure an illumination optical system, and illuminate an illuminated region in a subsequent stage.

Total reflection prism 105 is configured of two prisms, and thin air layer 106 is formed on adjacent surfaces of the prisms. Air layer 106 totally reflects light entering at an angle greater than or equal to a critical angle. Light from field lens 104 is reflected by a total reflection surface of total reflection prism 105 and enters color prism 107.

Color prism 107 is configured of three prisms, and blue-reflecting dichroic mirror 108 and red-reflecting dichroic mirror 109 are formed on adjacent surfaces of the respective prisms. Light entering color prism 107 is separated into blue colored light, red colored light, and green colored light by blue-reflecting dichroic mirror 108 and red-reflecting dichroic mirror 109, and the blue colored light, red colored light, and green colored light enter DMDs 110, 111, and 112, respectively. DMDs 110, 111, 112 deflect micromirrors in accordance with a video signal and reflect the light into light entering projection lens 113 and light traveling outside an effective range of projection lens 113. The light reflected by DMDs 110, 111, 112 is again transmitted through color prism 107. In the process of being transmitted through color prism 107, the separated blue colored light, red colored light, and green color light are combined and enter total reflection prism 105. Light entering total reflection prism 105 enters air layer 106 at a critical angle or less, and is thus transmitted through and enters projection lens 113.

In this way, image light formed by DMDs 110, 111, 112 is enlarged and projected on the screen (not shown). Since the light source device is configured of the plurality of solid-state light sources and emits the white light with high efficiency and good white balance, a projection display device having a long life and high brightness can be achieved. Further, since the DMDs are each used for the image forming element, it is possible to configure a projection display device having a higher light resistance and heat resistance than the image forming element using liquid crystal. Furthermore, since three DMDs are used, it is possible to obtain bright, high-definition projected images with good color reproduction.

As described above, light source device 40 used for the second projection display device of the fifth exemplary embodiment separates the blue light from the plurality of semiconductor lasers into two by the dichroic mirror, and efficiently combines the yellow light containing the green and red components, and the other separated blue light (second light), the yellow light being excited and emitting the light by one separated blue light (first light), by which the white light can be obtained, and further the other separated blue light is condensed using the lens array, so that light source device 40 is compact and highly efficient. Therefore, a compact, highly efficient projection display device can be configured. While light source device 40 shown in FIG. 1 is used as the light source device, light source devices 50, 51 shown in FIGS. 2, 4 may be used. In this case, a more compact light source device and projection display device can be configured.

### INDUSTRIAL APPLICABILITY

The present disclosure relates to a projection display device using an image forming element.

### REFERENCE MARKS IN THE DRAWINGS

11, 12 projection display device
20 semiconductor laser
21 heat dissipation plate
22 condensing lens
23, 45 heat sink
24 light flux
25, 26 lens
27 first diffusion plate
28 first retardation plate
29 dichroic mirror
30, 31, 46 condenser lens
32, 42, 52 florescent material layer
33, 43, 53 aluminum substrate
34 motor
35, 44, 54 fluorescent plate
36, 41 lens array
37, 47 second diffusion plate
38, 48 second retardation plate
39, 49 reflection plate
40, 50, 51 light source device
100 condensing lens
101 rod
102, 209, 210 relay lens
103, 206, 207, 208 reflection mirror
104, 211, 212, 213 field lens
105 total reflection prism
106 air layer
107 color prism
108, 204 blue-reflecting dichroic mirror
109 red-reflecting dichroic mirror
110, 111, 112 DMD
113, 224 projection lens
200 first lens array plate
201 second lens array plate
202 polarization conversion element
203 superimposing lens
205 green-reflecting dichroic mirror
214, 215, 216 incident-side polarization plate
217, 218, 219 liquid crystal panel
220, 221, 222 emission-side polarization plate
223 color combining prism

1. A light source device comprising:
a solid-state light source;
a dichroic mirror that separates light from the solid-state light source into first light and second light, and combines blue light and light containing green and red components, the blue light being obtained by converting polarization of the second light, the light containing green and red components being obtained by converting a wavelength of the first light;
a first condensing element that condenses the first light separated by the dichroic mirror;
a fluorescent plate that converts the wavelength of the first light condensed by the first condensing element;
a second condensing element that condenses the second light separated by the dichroic mirror;
a retardation plate that converts polarization of the second light condensed by the second condensing element; and
a reflection plate that reflects the second light with the polarization converted by the retardation plate,
wherein
the second condensing element is configured of a lens array.

2. A light source device comprising:
a solid-state light source;
a dichroic mirror that separates light from the solid-state light source into first light and second light, and combines blue light and light containing green and red components, the blue light being obtained by converting polarization of the second light, the light containing green and red components being obtained by converting a wavelength of the first light;
a first condensing element that condenses the first light separated by the dichroic mirror;
a fluorescent plate that converts the wavelength of the first light condensed by the first condensing element;
a second condensing element that condenses the second light separated by the dichroic mirror;
a retardation plate that converts polarization of the second light condensed by the second condensing element; and
a reflection plate that reflects the second light with the polarization converted by the retardation plate,
wherein
the first condensing element is configured of a lens array.

3. The light source device according to claim 2, wherein the second condensing element is configured of a lens array.

4. The light source device according to claim 1, wherein the lens array is configured of a plurality of lens arrays.

5. The light source device according to claim 1, wherein the fluorescent plate is a rotation-controllable circular substrate, and includes a fluorescent material layer on which a Ce-activated YAG yellow fluorescent material is formed.

6. The light source device according to claim 2, wherein the fluorescent plate is a non-rotating fixed substrate, and includes a fluorescent material layer on which a Ce-activated YAG yellow fluorescent material is formed.

7. The light source device according to claim 2, wherein the fluorescent plate is a non-rotating fixed substrate, and a fluorescent material layer is formed on an entire area of the non-rotating fixed substrate.

8. The light source device according to claim 2, wherein the fluorescent plate is a non-rotating fixed substrate, and a fluorescent material layer is formed in discrete partial regions of the non-rotating fixed substrate.

9. The light source device according to claim 1, wherein the solid-state light source is a blue semiconductor laser.

10. The light source device according to claim 1, wherein the light emitted from the solid-state light source is linearly polarized light.

11. The light source device according to claim 1, wherein the retardation plate is a ¼ wavelength plate.

12. The light source device according to claim 1, wherein the retardation plate is a thin film retardation plate using birefringence by oblique deposition.

13. The light source device according to claim 1, wherein the retardation plate is a fine-structured retardation plate using birefringence by a fine structure.

14. A projection display device comprising:
the light source device according to claim 1;
an illumination optical system that condenses light from the light source and illuminates an illuminated region;
an image forming element that receives light from the illumination optical system and forms an image in accordance with a video signal; and
a projection lens that enlarges and projects the image formed by the image forming element.

15. The projection display device according to claim 14, wherein the image forming element is a liquid crystal panel.

16. The projection display device according to claim 14, wherein the image forming element is a mirror deflection type digital micromirror device (DMD).

17. A projection display device comprising:
the light source device according to claim 2;
an illumination optical system that condenses light from the light source and illuminates an illuminated region;
an image forming element that receives light from the illumination optical system and forms an image in accordance with a video signal; and
a projection lens that enlarges and projects the image formed by the image forming element.

18. The projection display device according to claim 17, wherein the image forming element is a liquid crystal panel.

19. The projection display device according to claim 17, wherein the image forming element is a mirror deflection type digital micromirror device (DMD).
